(19) United States
(12) Patent Application Publication
(10) Pub. No.: US 2006/0059340 A1
(43) Pub. Date: Mar. 16, 2006

(54) Method and system for dynamic authentication and authorization

(76) Inventors: Jan Paul Eldenmalm, Stockholm (SE); Fredrik Lindgren, Solna (SE)

Correspondence Address: Jan Eldenmalm, Odengatan 6, Stockholm, 11424, SE

(21) Appl. No.: 10/937,371

(22) Filed: Sep. 10, 2004

(51) Int. Cl. H04L 9/00

(52) U.S. Cl. 713/168; 713/178; 709/223

(57) ABSTRACT

The method is for dynamically authenticating and authorizing a user. A request signal (104) is received from a user into a service unit (97). The service unit extracts identification information (101) from the request signal. The service unit evaluates the identification information and identifies potential users (X, Y, Z). The service unit assigns a probability value (Px, Py, Pz) to each identified potential user (X, Y, Z) to indicate a likelihood of correct identification of the potential users (X, Y, Z). The service unit provides rules sets (RSx, RSy, RSz) for the users (X, Y, Z). The probability requirements (PrRx, PrRy, PrRz) of each rule in the rules sets (RSx, RSy, RSz) are evaluated. The rules are applied for each (PrRx, PrRy, PrRz) less than or equal to (Px, Py, Pz).

### TECHNICAL FIELD

The present invention relates to a method and system for dynamic authentication and authorization of a user and wherein the rules and rights are dynamically allocated partly depending upon identification probabilities of possible users.

### BACKGROUND OF THE INVENTION

Many devices and methods have been developed in the past to authenticate potential users or machines. It has usually been necessary to match information provided by the user with information stored for identification purposes about the user.

For example, if the user enters the wrong personal identification number, the system, such as an automatic banking teller machine, rejects the user and the user cannot gain access to requested information through the automatic banking teller machine. This digital approach to authentication and authorization has required the development of complex mechanisms for authentication including distribution of complex technology. The digital approach also treats all users as either being accepted or rejected but cannot distinguish users in any other way and do not provide rejected users with service.

There is a need for an effective authentication system that is able to dynamically authenticate and authorize users.

### SUMMARY OF THE INVENTION

The method and device of the present invention provides a solution to the above-outlined problems. More particularly, the method of the present invention is for authenticating and authorizing a user in a dynamic way. A request signal is received from a user into a service unit. The service unit extracts identification information from the request signal. The service unit evaluates the identification information and identifies zero to several potential users (X, Y, Z). The service unit assigns a probability value (Px, Py, Pz) to each identified potential user (X, Y, Z) to indicate a likelihood of correct identification of the potential users (X, Y, Z). The service unit provides sets of rules (RSx, RSy, RSz) for the users (X, Y, Z). The probability requirements (PrRx, PrRy, PrRz) of each rule in the rules set (RSx, RSy, RSz) are evaluated. The rules in the rule sets (RSx, RSy, RSz) are applied for each (PrRx, PrRy, PrRz) less than or equal to (Px, Py, Pz). In this way, the rights of the user may dynamically change as the probability of correct identification changes.

### BRIEF DESCRIPTION OF THE DRAWINGS

FIG. 1 is a schematic illustration of the system of the present invention.

### DETAILED DESCRIPTION

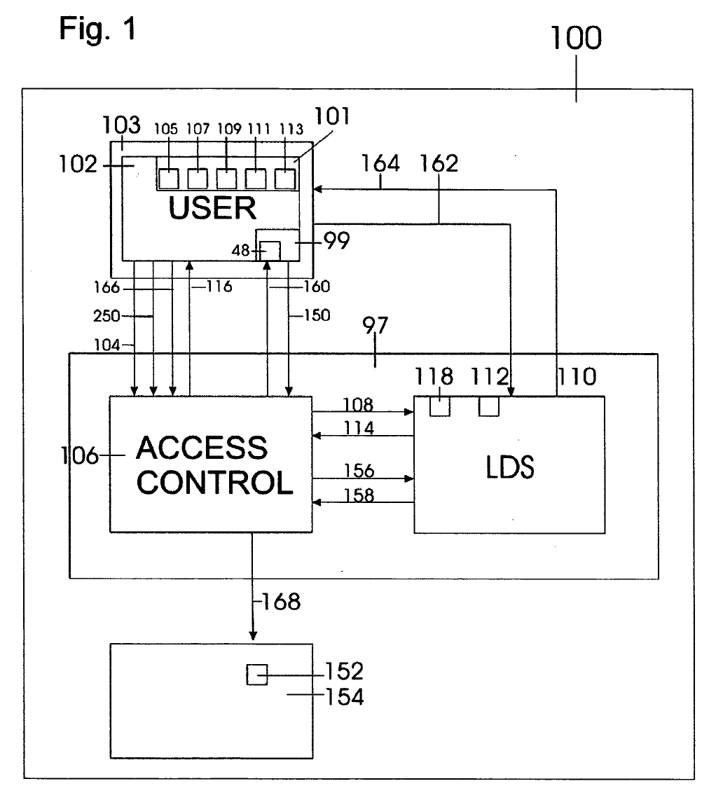

With reference to FIG. 1, the method and system 100 of the present invention is a dynamic authentication and authorization system that collects identification information 101 from a user 102. The user (102) may be a person, machine or any other entity. The collected information 101 is then evaluated and the system identifies a number of possible (0-n) identities of users (x,y,z) and provides some rights based on the possible users and their pre-allocated rights. The system may also consider the time and place of the user, when appropriate.

More particularly, the user 102 may send a DHCP (dynamic host configuration protocol) request signal 104 to a service unit 97, that may include an access control unit 106, to obtain an IP address so that the user 102 can communicate in a network 103. The access control unit 106 may act as a proxy or filter between the user and a central service such as an authentication gateway or login directory service unit (LDS) 110. The request signal 104 is often used when the user's computer 99 has a network card 98. The unit 106 receives the request signal 104 and extracts the identification information 101, such as userHOST name 105, userIP address 107, userMAC address 109 and sometimes userPLACE 111, from the request signal 104. The unit 106 may temporarily or permanently store the collected information (101) before the information is sent to the LDS unit 110 for further processing. The userHOST 105 may be the name of the computer. The userIP 107 may be the IP address of the user's network card 98 for the network 103. The DHCP protocol permits the user's computer to suggest a suitable IP address to the server. This suggested IP address may also be saved for identification purposes. The userMAC 109 is often unique to each network card 98 but it is possible to change this address information. The userPLACE 111 may be used to determine from which geographical place the request signal 104 is sent and the userTIME 113 may be used to determine when the request was sent. Other information may also be collected.

The access control unit 106 sends a request signal 108, including the collected information 101 from the request signal 104, to the login directory service (LDS) unit 110 to obtain rules for User (102). One function of the access control unit 106 is to implement the rights of the user (102), as provided by the LDS (110). Each time the unit (106) sends new information about the user (102) to the unit 110, the access control unit 106 may obtain updated rules or rights that apply to the user (102). As described in detail below, based on collected information, the unit 110 may identify zero or several potential users (x,y,z,n) and allocate identification probabilities to each potential user (x,y,z,n). The unit 110 then determines the rules that apply to the potential users in view of the identification probabilities. In this way, the unit 110 receives the request signal 108 and determines rules 112 that apply. The unit 110 sends a response signal 114, including the rules 112, back to the unit 106. It is to be understood that the communication between the unit 106 and the unit 110 may be a continuous process so that the unit 106 is provided with updated rules many times. The response signal 114 may contain zero or several rules. The unit 106 receives the response signal 114 and implements the rules 112 within the permitted time limits. The unit 106 sends a response signal 116 back to the user 112 including the IP address that was requested by the user 102 in the request signal 104. The unit 106 may or may not be concerned with potential users (x,y,z,n) and their identity probabilities, it is focused on whether there are matching rules associated with the user (102) to permit the user (102) access to the requested resource. The unit 106 may be designed with more sophisticated features.

When, for example, the user 102 is trying to do something that the user (102) has no right to do, such as contacting a restricted resource, the control unit 106 may direct the unauthorized user (102) to the LDS unit 110 so that it can inform the user (102) that the user (102) does not have the right to communicate with the requested resource.

More particularly, the user 102 may send a request signal 150 to a resource, such as a resource 152 on the network 154 to which access is controlled by the system (97). The access control unit 106 may intercept the signal 150, when the user 102 is unauthorized, and send an update authorization request signal 156 to the LDS unit 110 to obtain the updated rules that apply to the user 102. The LDS unit processes the update request signal 156 and sends back a return signal 158 with updated rules. The control unit 106 reviews the rules and determines if there is a rule that gives the user the right to access the requested resource 152. If the user has the right to access the requested resource 152, the control unit 106 provides such access. If the unit 106 cannot find a matching rule that provide the user with access, the unit 106 may apply an intercepting rule and send back a redirect signal 160 to the user, to redirect the user to the LDS unit 110 for further information. The user (102) may then send a request signal 162 directly to the LDS unit 110. The LDS unit 110 may request login information and/or payment from the user 102 as a result of the request signal 162. The unit 110 may then send a redirect signal 164 to the user suggesting that the user 102 reattempts to reach the previously restricted resource. The user may then proceed and send the request signal 166 to gain access to the resource 152. The access control unit 106 will again update its rules from the LDS unit 110 and find the matching rules to grant the user 102 accesses to the resource 152 by forwarding a signal 168 to the resource 152.

When the LDS unit 110 communicates directly with the user 102, perhaps as a result of the redirect signal 160 it is sometimes possible to read and store server created information on the user equipment 99, this may be in the form of a browser cookie. This information when available can be used for additional authentication of the user 102. The information stored may include a one-time password so that the server may request the information the next time the same computer visits and thus improve authentication in an automated manner. As described in detail below, the user 102 may gain more rights as a result of the additional information provided through the request so that the user 102 is granted the right to contact the requested resource 152.

An important aspect of the method of the present invention is that the collected information from the user 102 is evaluated to determine the probability that the user (102) actually is any known user. For example, the user (102) may provide a set of information that may include none, some, all or other parameters then the following: login name, password, session identification, SMS identification, SIM identification, computer name, web browser, hardware identification on the local network (MAC) and current place from where the request signal is sent. Other parameters may also be used and the above list is merely an illustrative example of possible parameters. Each parameter, or combinations of parameters, may be assigned a probability value (P) to indicate the probability assigned to a user (x,y,z,n) being the user 102, as a result of a correct match of the parameter(s) and historical data. It should be noted that two separately accepted parameters could imply two different users, when presented in conjunction, can exclude both potential users. An example of this can be presenting the loginname of one, and the password of the other. In general, the less likelihood that a parameter can be altered or falsified, the higher the probability value that a user (x,y,z,n) is assigned after a correct match. For example, if the user (102) has an identification parameter with a value known to be connected with the user (x), and the parameter has a probability of identification value of 20%, the user (102) is considered being identified as the user (x) with a probability of 20%. Similarly if the user (102) has another identification parameter with a value known to be connected with user (x) and the parameter has a probability of identification of 30%, the user (102) is identified as the user (x) with a joint probability of 50%. Similarly, each parameter may be assigned identification probability values. For security reasons some parameters are only evaluated in conjunction with one or more other parameters. When the probability increases for one user, such as for the user (x), the probability for all other users naturally decreases.

The rules or rights assigned to a user 102 are evaluated in a certain defined order so that certain rules may have an explicit higher priority, and thus are evaluated before, than others. The rules do not have to be rights but can also be rules that deny access, redirects or carry out other logic manipulations of the user (102) request(s). A rule that provides access to many services may be given a relatively low priority but require a high identification probability. On the other hand, prohibition rules may be given a higher priority but require a very low, or no, identification probability. In this way, a prohibition rule that prevent user (102) from accessing a certain service may be given a high priority and apply independently of the identification probability of the users (x,y,z,n) in user 102.

Each time new information is obtained about user 102, the current rules set is updated. New rules may be added for user 102 to improve the likelihood of correctly identifying a user (x,y,z,n). A user (102) may be identified by matching the information of the signal 104 with historical data. This matching may result in a list of possible users (x,y,z,n) potentially including an estimate of the probability of each user (x,y,z,n) actually being the user (102). The list may look like the table below:

| User | Probability |
|---|---|
| X | 0.1 |
| Y | 0.2 |
| Z | 0.6 |

Another important feature of the present invention is that the user is assigned rules/rights based on the probability values. For example, each user (x,y,z,n) may be entitled certain rights to use the system and these rights are connected to the probability that the user (x,y,z,n) is correctly identified by the system. One purpose of the system is thus to allocate the correct amount of rights although the user (102) is relatively unknown. The higher the probability value is that the user (102) is correctly identified the more predetermined rights are assigned to the user (102). For example, if the user 102 cannot provide correct password and login name for any user (x,y,z,n), only a very limited amount of rights are allocated to the user 102, in extreme cases no rights at all.

Once it has been determined that the likely users are user X, user Y or user Z, the LDS unit 110 may instruct the access control unit 106 to try to further refine the identification, in an extended identification procedure by, for example, using information related to a SIM card or a soft SIM of one of the identified possible users that may be stored by the LDS unit 110. The second procedure can be differentiated depending on identified users, thus the identification procedure can be adapted to the identified users. If the second identification procedure is successful, the likelihood that the correct user has been identified has increased and the user may be granted more rights.

As indicated above, each user may be allocated rules/rights that are based on the probability that the particular user is correctly identified. It should be noted that the pre-set rights allocated to different users may be different although the likelihood of the users being correctly identified is the same. The allocation of the predetermined rights may be allocated according to the table below:

| Probability | User X | User Y | User Z |
|---|---|---|---|
| 0.8 and up | Anything | Anything | — |
| 0.5 and up | — | Printer | — |
| >0.0 and up | Mail server | Intranet | IP:1234567 |

This means that user (102) will be allocated all rights if the probability of correct identification of user X, based on the parameters discussed above, is 0.8 or higher. The user (102) will have the right to access the mail server if the likelihood that the user 102 is user X is higher than 0.0. Similarly, the user (102) will be allocated all rights if the probability is 0.8 or higher that user Y is correctly identified. The user (102) will have the right to use the printer when the likelihood is 0.5 or higher for the user Y and access to the intranet when the probability is higher than 0.0. The user (102) will be granted access to a certain IP address when the probability is higher than 0.0 for the user Z. It should be noted that the user X requires a probability of 0.8 or higher to gain access to the printer. Even if the probability is close to 100%, the user Z will never gain access to any other service in addition to the particular IP address.

According to the above probabilities and probability requirements, user (102) will be allocated the following rights, as shown in the table below:

| User | Probability | Rights |
|---|---|---|
| X | 0.1 | Mail server |
| Y | 0.2 | Intranet |
| Z | 0.6 | IP:1234567 |

Because the system has identified a group of possible users X, Y and Z it is not certain who the user (102) actually is, the system will deliver all valid rules given the three identified users X, Y, Z, such as mail server, Intranet, and IP 1234567. User Y's printer right is not allocated to user (102) since it requires an identification probability of user Y that is higher than 0.5. Similarly, the “anything” rule is not allocated since neither user X nor user Y is identified with a probability that is 0.8 or higher.

It is also possible to adjust the allocation of rights based on parameters that are not directly associated with the users. The system may have a filtration feature. For example, the place from where the request signal is sent, the hardware used, such as a network card, and the time the request signal is sent by the user may be taken into consideration. This could mean that the user Z may only have access to the IP address when the user Z is sending the request during working hours from an office computer that is located at a certain location. If the user Z moves the office computer to home so that the office computer is at a new location, the system may be set not to allocate the user Z the right to the IP address in view of the filter setting to require that the office computer must be located at the work place. The allocation of rights may be expanded depending upon which service operator the user is using such as a special service operator display. The rights allocated may thus depend upon the user, the hardware, the user software, the place, the time, the service operator and the LDS session because the session in itself may carry some rights.

While the present invention has been described in accordance with preferred compositions and embodiments, it is to be understood that certain substitutions and alterations may be made thereto without departing from the spirit and scope of the following claims.

1. A method for dynamically authenticating and authorizing a user, comprising:
receiving a request signal (104) from a user into a service unit (97);
the service unit extracting identification information (101) from the request signal;
the service unit evaluating the identification information and identifying potential users (X, Y, Z);
the service unit assigning a probability value (Px, Py, Pz) to each identified potential user (X, Y, Z) to indicate a likelihood of correct identification of the potential users (X, Y, Z);
the service unit providing sets of rules (RSx, RSy, RSz) for the users (X, Y, Z);
evaluating probability requirements (PrRx, PrRy, PrRz) of each rule in the rule sets (RSx, RSy, RSz); and
applying the rules in rule sets (RSx, RSy, RSz) for each (PrRx, PrRy, PrRz) less than or equal to (Px, Py, Pz).

2. The method according to claim 1 wherein the method further comprises using the initially identified potential users to extend an identification procedure with user adapted identification procedures.

3. The method according to claim 1 wherein rules are applied to a user (102) in a defined order depending on priority of valid rules.

4. The method according to claim 1 wherein the method further comprises providing an access control unit (106) and a login directory service unit (110) and the unit (106) sending a rule request signal (108) to the unit (110).

5. The method according to claim 4 wherein the method further comprises the unit (106) intercepting a user's request signal (150) when the unit (106) has no matching rules for a requested resource (152).

6. The method according to claim 4 wherein the method further comprises the unit (106) extracting information from the request signal (104) comprising userHOST (105), userIP (107) and userMAC (109), userTIME (113) and userPLACE (111).

7. The method according to claim 4 wherein the method further comprises the unit (106) redirecting the user to the unit (110).

8. The method according to claim 4 wherein the method further comprises the unit (110) providing rules for the user (102) to gain access to the resource (152).

9. The method according to claim 4 wherein the method further comprises the unit (106) requesting updates.

10. The method according to claim 4 wherein the method further comprises the unit (106) extracting userPLACE (111) and userTIME (113) from the interaction with the user.
